(19) United States
(12) Patent Application Publication
(10) Pub. No.: US 2026/0134278 A1
(43) Pub. Date: May 14, 2026

(54) Method, System, and Computer Program Product for Providing a Framework to Improve Discrimination of Graph Features by a Graph Neural Network

(71) Applicant: Visa International Service Association, San Francisco, CA (US)

(72) Inventors: Huiyuan Chen, San Jose, CA (US); Mahashweta Das, Campbell, CA (US); Michael Yeh, Newark, CA (US); Yan Zheng, Los Gatos, CA (US); Vivian Wan Yin Lai, Atlanta, GA (US); Hao Yang, San Jose, CA (US)

(21) Appl. No.: 19/119,643

(22) PCT Filed: Oct. 9, 2023
(86) PCT No.: PCT/US2023/034715

§ 371 Date: Apr. 9, 2025

(30) Foreign Application Priority Data
Oct. 12, 2022 (US) 63415373

(51) Int. Cl. G06N 3/08; G06N 3/042

(52) U.S. Cl. CPC G06N 3/08; G06N 3/042

(57) ABSTRACT

Provided are methods for enhancing a distribution of graph feature embeddings in an embedding space to improve discrimination of graph features by a graph neural network (GNN) that may include receiving a dataset comprising graph data associated with a graph, calculating a distance between a first set of node embeddings and a second set of node embeddings, determining a measure of uniformity for the dataset, determining a plurality of groups of node embeddings, determining a measure of alignment for the plurality of groups of node embeddings, generating a set of graph features based on the measure of uniformity, the measure of alignment, and the distance, and training the GNN based on the set of graph features to provide a trained GNN. Systems and computer program products are also disclosed.

### CROSS-REFERENCE TO RELATED APPLICATIONS

This application is the United States national phase of International Application No. PCT/US23/34715 filed Oct. 9, 2023, and claims the benefit of U.S. Provisional Application No. 63/415,373, filed Oct. 12, 2022, the disclosures of which are hereby incorporated by reference in their entireties.

### BACKGROUND

### 1. Technical Field

This disclosure relates generally to graph neural networks and, in some non-limiting embodiments or aspects, to methods, systems, and computer program products for enhancing a distribution of graph feature embeddings in an embedding space to improve discrimination of graph features by a graph neural network (GNN).

### 2. Technical Considerations

Some machine learning models, such as neural networks (e.g., a convolutional neural network), may receive an input dataset including data points for training. Each data point in the training dataset may have a different effect on a neural network (e.g., a trained neural network) generated based on training the neural network after the neural network is trained. In some instances, input datasets designed for neural networks may be independent and identically distributed. Input datasets that are independent and identically distributed may be used to determine an effect (e.g., an influence) of each data point of the input dataset.

Graph neural networks (GNNs) are designed to receive graph data (e.g., graph data representing graphs) and the graph data may include nodes and edges. A GNN may include graph embeddings (e.g., node data embeddings regarding a graph, edge data embeddings regarding a graph, etc.) that provide low-dimensional feature vector representations of nodes in the GNN such that some property of the GNN is preserved. A GNN may be used to determine relationships (e.g., hidden relationships) among entities.

However, as node representations, in the form of graph embeddings, progress into deeper layers of a GNN, the node representation may converge to have the same values. In this way, the GNN may fail to detect relationships among entities. Further, adding perturbations to the original graph data that was used to generate the GNN may result in decreased performance, in terms of accuracy, time to train, and/or the like, of the GNN.

### SUMMARY

Accordingly, provided are improved methods, systems, and computer program products for a process for enhancing a distribution of graph feature embeddings in an embedding space to improve discrimination of graph features by a graph neural.

According to non-limiting embodiments or aspects, provided is a system including: at least one processor programmed or configured to: receive a dataset including graph data associated with a graph, the graph including a plurality of nodes and a plurality of edges, the graph data including a plurality of node embeddings associated with a number of nodes in the graph and node data associated with each node of the graph, where the node data includes data associated with parameters of each node in the graph; calculate a distance between a first set of node embeddings of the plurality of node embeddings and a second set of node embeddings of the plurality of node embeddings in an embedding space, where the plurality of node embeddings are based on the node data associated with each node of the graph; determine a measure of uniformity for the dataset, where the measure of uniformity is associated with a measure of distribution of the plurality of node embeddings in the embedding space; determine a plurality of groups of node embeddings, each group of the plurality of groups of node embeddings including at least a portion of the plurality of node embeddings; determine a measure of alignment for the plurality of groups of node embeddings, where the measure of alignment is associated with a measure of distribution of at least a portion of node embeddings of each group of the plurality of groups of node embeddings; generate a set of graph features based on the measure of uniformity, the measure of alignment, and the distance between the first set of node embeddings and the second set of node embeddings; and train a graph neural network (GNN) based on the set of graph features to provide a trained GNN.

In some non-limiting embodiments or aspects, the at least one processor may be further programmed or configured to validate the trained GNN based on at least a portion of the set of graph features.

In some non-limiting embodiments or aspects, when calculating the distance between the first set of node embeddings and the second set of node embeddings in the embedding space, the at least one processor may be programmed or configured to calculate a Euclidean distance between each first node embedding of the first set of node embeddings and each second node embedding of the second set of node embeddings to provide a plurality of Euclidean distances.

In some non-limiting embodiments or aspects, when determining the measure of uniformity for the dataset, the at least one processor may be programmed or configured to determine the measure of uniformity for the dataset based on the number of nodes in the graph and the data associated with the parameters of each node in the graph, where the measure of uniformity may be associated with a number of bits to encode the first set of node embeddings and the second set of node embeddings.

In some non-limiting embodiments or aspects, when determining the plurality of groups of node embeddings, the at least one processor may be programmed or configured to: determine the plurality of groups of node embeddings based on a probability matrix including a plurality of rows and a plurality of columns, each group of the plurality of groups of node embeddings including at least a portion of the plurality of node embeddings, and each row of the probability matrix including a plurality of measures of probability, where each row of the probability matrix may correspond to a node of the plurality of nodes and each column of the probability matrix corresponds to a group of the plurality of groups of node embeddings, and where each measure of probability of the plurality of measures of probability may represent a probability that the node will be assigned to the group based on the row and the column of the probability matrix; and where, when determining the measure of alignment for the plurality of groups of node embeddings, the at least one processor may be programmed or configured to: determine the measure of alignment based on the probability matrix, the number of nodes in the graph and the data associated with the parameters of each node in the graph, where the measure of alignment may be associated with a number of bits to encode each group of the plurality of groups of node embeddings.

In some non-limiting embodiments or aspects, the node data may include user data associated with a plurality of users and entity data associated with a plurality of entities, and where the first set of node embeddings may be based on the user data and the second set of node embeddings is based on the entity data.

In some non-limiting embodiments or aspects, when determining the plurality of groups of node embeddings, the at least one processor may be programmed or configured to: determine each group of the plurality of groups of node embeddings based on nearest neighbors of the plurality of nodes in the graph using an adjacency matrix and a degree of each node of the plurality of nodes.

According to non-limiting embodiments or aspects, provided is a computer-implemented method including: receiving, with at least one processor, a dataset including graph data associated with a graph, the graph including a plurality of nodes and a plurality of edges, the graph data including a plurality of node embeddings associated with a number of nodes in the graph and node data associated with each node of the graph, where the node data includes data associated with parameters of each node in the graph; calculating, with at least one processor, a distance between a first set of node embeddings of the plurality of node embeddings and a second set of node embeddings of the plurality of node embeddings in an embedding space, where the plurality of node embeddings are based on the node data associated with each node of the graph; determining, with at least one processor, a measure of uniformity for the dataset, where the measure of uniformity is associated with a measure of distribution of the plurality of node embeddings in the embedding space; determining, with at least one processor, a plurality of groups of node embeddings, each group of the plurality of groups of node embeddings including at least a portion of the plurality of node embeddings; determining, with at least one processor, a measure of alignment for the plurality of groups of node embeddings, where the measure of alignment is associated with a measure of distribution of at least a portion of node embeddings of each group of the plurality of groups of node embeddings; generating, with at least one processor, a set of graph features based on the measure of uniformity, the measure of alignment, and the distance between the first set of node embeddings and the second set of node embeddings; and training, with at least one processor, a graph neural network (GNN) based on the set of graph features to provide a trained GNN.

In some non-limiting embodiments or aspects, the computer-implemented method may include validating, with at least one processor, the trained GNN based on at least a portion of the set of graph features.

In some non-limiting embodiments or aspects, calculating the distance between the first set of node embeddings and the second set of node embeddings in the embedding space may include calculating a Euclidean distance between each first node embedding of the first set of node embeddings and each second node embedding of the second set of node embeddings to provide a plurality of Euclidean distances.

In some non-limiting embodiments or aspects, determining the measure of uniformity for the dataset may include determining the measure of uniformity for the dataset based on the number of nodes in the graph and the data associated with the parameters of each node in the graph, where the measure of uniformity may be associated with a number of bits to encode the first set of node embeddings and the second set of node embeddings.

In some non-limiting embodiments or aspects, determining the plurality of groups of node embeddings may include: determining the plurality of groups of node embeddings based on a probability matrix including a plurality of rows and a plurality of columns, each group of the plurality of groups of node embeddings including at least a portion of the plurality of node embeddings, and each row of the probability matrix including a plurality of measures of probability, where each row of the probability matrix may correspond to a node of the plurality of nodes and each column of the probability matrix corresponds to a group of the plurality of groups of node embeddings, and where each measure of probability of the plurality of measures of probability may represent a probability that the node will be assigned to the group based on the row and the column of the probability matrix; and where determining the measure of alignment for the plurality of groups of node embeddings may include: determining the measure of alignment based on the probability matrix, the number of nodes in the graph and the data associated with the parameters of each node in the graph, where the measure of alignment may be associated with a number of bits to encode each group of the plurality of groups of node embeddings.

In some non-limiting embodiments or aspects, the node data may include user data associated with a plurality of users and entity data associated with a plurality of entities, and where the first set of node embeddings may be based on the user data and the second set of node embeddings is based on the entity data.

In some non-limiting embodiments or aspects, determining the plurality of groups of node embeddings may include determining each group of the plurality of groups of node embeddings based on nearest neighbors of the plurality of nodes in the graph using an adjacency matrix and a degree of each node in the plurality of nodes.

According to non-limiting embodiments or aspects, provided is a computer program product including at least one non-transitory computer-readable medium including one or more instructions that, when executed by at least one processor, cause the at least one processor to: receive a dataset including graph data associated with a graph, the graph including a plurality of nodes and a plurality of edges, the graph data including a plurality of node embeddings associated with a number of nodes in the graph and node data associated with each node of the graph, where the node data includes data associated with parameters of each node in the graph; calculate a distance between a first set of node embeddings of the plurality of node embeddings and a second set of node embeddings of the plurality of node embeddings in an embedding space, where the plurality of node embeddings are based on the node data associated with each node of the graph; determine a measure of uniformity for the dataset, where the measure of uniformity is associated with a measure of distribution of the plurality of node embeddings in the embedding space; determine a plurality of groups of node embeddings, each group of the plurality of groups of node embeddings including at least a portion of the plurality of node embeddings; determine a measure of alignment for the plurality of groups of node embeddings, where the measure of alignment is associated with a measure of distribution of at least a portion of node embeddings of each group of the plurality of groups of node embeddings; generate a set of graph features based on the measure of uniformity, the measure of alignment, and the distance between the first set of node embeddings and the second set of node embeddings; and train a graph neural network (GNN) based on the set of graph features to provide a trained GNN.

In some non-limiting embodiments or aspects, the one or more instructions may further cause the at least one processor to validate the trained GNN based on at least a portion of the set of graph features.

In some non-limiting embodiments or aspects, the one or more instructions that cause the at least one processor to calculate the distance between the first set of node embeddings and the second set of node embeddings in the embedding space may cause the at least one processor to calculate a Euclidean distance between each first node embedding of the first set of node embeddings and each second node embedding of the second set of node embeddings to provide a plurality of Euclidean distances.

In some non-limiting embodiments or aspects, the one or more instructions that cause the at least one processor to determine the measure of uniformity for the dataset may cause the at least one processor to: determine the measure of uniformity for the dataset based on the number of nodes in the graph and the data associated with the parameters of each node in the graph, where the measure of uniformity may be associated with a number of bits to encode the first set of node embeddings and the second set of node embeddings.

In some non-limiting embodiments or aspects, the one or more instructions that cause the at least one processor to determine the plurality of groups of node embeddings may cause the at least one processor to: determine the plurality of groups of node embeddings based on a probability matrix including a plurality of rows and a plurality of columns, each group of the plurality of groups of node embeddings including at least a portion of the plurality of node embeddings, and each row of the probability matrix including a plurality of measures of probability, where each row of the probability matrix may correspond to a node of the plurality of nodes and each column of the probability matrix corresponds to a group of the plurality of groups of node embeddings, and where each measure of probability of the plurality of measures of probability may represent a probability that the node will be assigned to the group based on the row and the column of the probability matrix; and where, the one or more instructions that cause the at least one processor to determine the measure of alignment for the plurality of groups of node embeddings may cause the at least one processor to: determine the measure of alignment based on the probability matrix, the number of nodes in the graph and the data associated with the parameters of each node in the graph, where the measure of alignment may be associated with a number of bits to encode each group of the plurality of groups of node embeddings.

In some non-limiting embodiments or aspects, the one or more instructions that cause the at least one processor to determine the plurality of groups of node embeddings may cause the at least one processor to determine each group of the plurality of groups of node embeddings based on nearest neighbors of the plurality of nodes in the graph using an adjacency matrix and a degree of each node of the plurality of nodes.

Further non-limiting embodiments or aspects are set forth in the following numbered clauses:
Clause 1: A system, comprising: at least one processor programmed or configured to: receive a dataset comprising graph data associated with a graph, the graph comprising a plurality of nodes and a plurality of edges, the graph data comprising a plurality of node embeddings associated with a number of nodes in the graph and node data associated with each node of the graph, wherein the node data comprises data associated with parameters of each node in the graph; calculate a distance between a first set of node embeddings of the plurality of node embeddings and a second set of node embeddings of the plurality of node embeddings in an embedding space, wherein the plurality of node embeddings are based on the node data associated with each node of the graph; determine a measure of uniformity for the dataset, wherein the measure of uniformity is associated with a measure of distribution of the plurality of node embeddings in the embedding space; determine a plurality of groups of node embeddings, each group of the plurality of groups of node embeddings comprising at least a portion of the plurality of node embeddings; determine a measure of alignment for the plurality of groups of node embeddings, wherein the measure of alignment is associated with a measure of distribution of at least a portion of node embeddings of each group of the plurality of groups of node embeddings; generate a set of graph features based on the measure of uniformity, the measure of alignment, and the distance between the first set of node embeddings and the second set of node embeddings; and train a graph neural network (GNN) based on the set of graph features to provide a trained GNN.
Clause 2: The system of clause 1, wherein the at least one processor is further programmed or configured to: validate the trained GNN based on at least a portion of the set of graph features.
Clause 3: The system of clause 1 or 2, wherein, when calculating the distance between the first set of node embeddings and the second set of node embeddings in the embedding space, the at least one processor is programmed or configured to: calculate a Euclidean distance between each first node embedding of the first set of node embeddings and each second node embedding of the second set of node embeddings to provide a plurality of Euclidean distances.
Clause 4: The system of any of clauses 1-3, wherein, when determining the measure of uniformity for the dataset, the at least one processor is programmed or configured to: determine the measure of uniformity for the dataset based on the number of nodes in the graph and the data associated with the parameters of each node in the graph, wherein the measure of uniformity is associated with a number of bits to encode the first set of node embeddings and the second set of node embeddings.
Clause 5: The system of any of clauses 1-4, wherein, when determining the plurality of groups of node embeddings, the at least one processor is programmed or configured to: determine the plurality of groups of node embeddings based on a probability matrix comprising a plurality of rows and a plurality of columns, each group of the plurality of groups of node embeddings comprising at least a portion of the plurality of node embeddings, and each row of the probability matrix comprising a plurality of measures of probability, wherein each row of the probability matrix corresponds to a node of the plurality of nodes and each column of the probability matrix corresponds to a group of the plurality of groups of node embeddings, and wherein each measure of probability of the plurality of measures of probability represents a probability that the node will be assigned to the group based on the row and the column of the probability matrix; and wherein, when determining the measure of alignment for the plurality of groups of node embeddings, the at least one processor is programmed or configured to: determine the measure of alignment based on the probability matrix, the number of nodes in the graph and the data associated with the parameters of each node in the graph, wherein the measure of alignment is associated with a number of bits to encode each group of the plurality of groups of node embeddings.
Clause 6: The system of any of clauses 1-5, wherein the node data comprises user data associated with a plurality of users and entity data associated with a plurality of entities, and wherein the first set of node embeddings is based on the user data and the second set of node embeddings is based on the entity data.
Clause 7: The system of any of clauses 1-6, wherein, when determining the plurality of groups of node embeddings, the at least one processor is programmed or configured to: determine each group of the plurality of groups of node embeddings based on nearest neighbors of the plurality of nodes in the graph using an adjacency matrix and a degree of each node of the plurality of nodes.
Clause 8: A computer-implemented method, comprising: receiving, with at least one processor, a dataset comprising graph data associated with a graph, the graph comprising a plurality of nodes and a plurality of edges, the graph data comprising a plurality of node embeddings associated with a number of nodes in the graph and node data associated with each node of the graph, wherein the node data comprises data associated with parameters of each node in the graph; calculating, with at least one processor, a distance between a first set of node embeddings of the plurality of node embeddings and a second set of node embeddings of the plurality of node embeddings in an embedding space, wherein the plurality of node embeddings are based on the node data associated with each node of the graph; determining, with at least one processor, a measure of uniformity for the dataset, wherein the measure of uniformity is associated with a measure of distribution of the plurality of node embeddings in the embedding space; determining, with at least one processor, a plurality of groups of node embeddings, each group of the plurality of groups of node embeddings comprising at least a portion of the plurality of node embeddings; determining, with at least one processor, a measure of alignment for the plurality of groups of node embeddings, wherein the measure of alignment is associated with a measure of distribution of at least a portion of node embeddings of each group of the plurality of groups of node embeddings; generating, with at least one processor, a set of graph features based on the measure of uniformity, the measure of alignment, and the distance between the first set of node embeddings and the second set of node embeddings; and training, with at least one processor, a graph neural network (GNN) based on the set of graph features to provide a trained GNN.
Clause 9: The computer-implemented method of clause 8, further comprising: validating, with at least one processor, the trained GNN based on at least a portion of the set of graph features.
Clause 10: The computer-implemented method of clause 8 or 9, wherein calculating the distance between the first set of node embeddings and the second set of node embeddings in the embedding space comprises: calculating a Euclidean distance between each first node embedding of the first set of node embeddings and each second node embedding of the second set of node embeddings to provide a plurality of Euclidean distances.
Clause 11: The computer-implemented method of any of clauses 8-10, wherein determining the measure of uniformity for the dataset comprises: determining the measure of uniformity for the dataset based on the number of nodes in the graph and the data associated with the parameters of each node in the graph, wherein the measure of uniformity is associated with a number of bits to encode the first set of node embeddings and the second set of node embeddings.
Clause 12: The computer-implemented method of any of clauses 8-11, wherein determining the plurality of groups of node embeddings comprises: determining the plurality of groups of node embeddings based on a probability matrix comprising a plurality of rows and a plurality of columns, each group of the plurality of groups of node embeddings comprising at least a portion of the plurality of node embeddings, and row of the probability matrix comprising a plurality of measures of probability, wherein each row of the probability matrix corresponds to a node of the plurality of nodes and each column of the probability matrix corresponds to a group of the plurality of groups of node embeddings, and wherein each measure of probability of the plurality of measures of probability represents a probability that the node will be assigned to the group based on the row and the column of the probability matrix; and wherein determining the measure of alignment for the plurality of groups of node embeddings comprises: determining the measure of alignment based on the probability matrix, the number of nodes in the graph and the data associated with the parameters of each node in the graph, wherein the measure of alignment is associated with a number of bits to encode each group of the plurality of groups of node embeddings.
Clause 13: The computer-implemented method of any of clauses 8-12, wherein the node data comprises user data associated with a plurality of users and entity data associated with a plurality of entities, and wherein the first set of node embeddings is based on the user data and the second set of node embeddings is based on the entity data.
Clause 14: The computer-implemented method of any of clauses 8-13, wherein determining the plurality of groups of node embeddings comprises determining each group of the plurality of groups of node embeddings based on nearest neighbors of the plurality of nodes in the graph using an adjacency matrix and a degree of each node in the plurality of nodes.
Clause 15: A computer program product comprising at least one non-transitory computer-readable medium comprising one or more instructions that, when executed by at least one processor, cause the at least one processor to: receive a dataset comprising graph data associated with a graph, the graph comprising a plurality of nodes and a plurality of edges, the graph data comprising a plurality of node embeddings associated with a number of nodes in the graph and node data associated with each node of the graph, wherein the node data comprises data associated with parameters of each node in the graph; calculate a distance between a first set of node embeddings of the plurality of node embeddings and a second set of node embeddings of the plurality of node embeddings in an embedding space, wherein the plurality of node embeddings are based on the node data associated with each node of the graph; determine a measure of uniformity for the dataset, wherein the measure of uniformity is associated with a measure of distribution of the plurality of node embeddings in the embedding space; determine a plurality of groups of node embeddings, each group of the plurality of groups of node embeddings comprising at least a portion of the plurality of node embeddings; determine a measure of alignment for the plurality of groups of node embeddings, wherein the measure of alignment is associated with a measure of distribution of at least a portion of node embeddings of each group of the plurality of groups of node embeddings; generate a set of graph features based on the measure of uniformity, the measure of alignment, and the distance between the first set of node embeddings and the second set of node embeddings; and train a graph neural network (GNN) based on the set of graph features to provide a trained GNN.
Clause 16: The computer program product of clause 15, wherein the one or more instructions further cause the at least one processor to: validate the trained GNN based on at least a portion of the set of graph features.
Clause 17: The computer program product of clause 15 or 16, wherein the one or more instructions that cause the at least one processor to calculate the distance between the first set of node embeddings and the second set of node embeddings in the embedding space cause the at least one processor to: calculate a Euclidean distance between each first node embedding of the first set of node embeddings and each second node embedding of the second set of node embeddings to provide a plurality of Euclidean distances.
Clause 18: The computer program product of any of clauses 15-17, wherein the one or more instructions that cause the at least one processor to determine the measure of uniformity for the dataset cause the at least one processor to: determine the measure of uniformity for the dataset based on the number of nodes in the graph and the data associated with the parameters of each node in the graph, wherein the measure of uniformity is associated with a number of bits to encode the first set of node embeddings and the second set of node embeddings.
Clause 19: The computer program product of any of clauses 15-18, wherein the one or more instructions that cause the at least one processor to determining the plurality of groups of node embeddings, the at least one processor is programmed or configured to: determine the plurality of groups of node embeddings based on a probability matrix comprising a plurality of rows and a plurality of columns, each group of the plurality of groups of node embeddings comprising at least a portion of the plurality of node embeddings, and each row of the probability matrix comprising a plurality of measures of probability, wherein each row of the probability matrix corresponds to a node of the plurality of nodes and each column of the probability matrix corresponds to a group of the plurality of groups of node embeddings, and wherein each measure of probability of the plurality of measures of probability represents a probability that the node will be assigned to the group based on the row and the column of the probability matrix; and wherein, the one or more instructions that cause the at least one processor to determine the measure of alignment for the plurality of groups of node embeddings cause the at least one processor to: determine the measure of alignment based on the probability matrix, the number of nodes in the graph and the data associated with the parameters of each node in the graph, wherein the measure of alignment is associated with a number of bits to encode each group of the plurality of groups of node embeddings.
Clause 20: The computer program product of any of clauses 15-19, wherein the one or more instructions that cause the at least one processor to determine the plurality of groups of node embeddings cause the at least one processor to: determine each group of the plurality of groups of node embeddings based on nearest neighbors of the plurality of nodes in the graph using an adjacency matrix and a degree of each node of the plurality of nodes.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of a non-limiting embodiment or aspect of an environment in which methods, systems, and/or computer program products, described herein, may be implemented according to the principles of the presently disclosed subject matter;

FIG. 2 is a diagram of a non-limiting embodiment or aspect of a graph learning system according to the principles of the presently disclosed subject matter;

FIG. 3 is a schematic diagram of a non-limiting embodiment or aspect of an embedding space over which an alignment function is applied according to the principles of the presently disclosed subject matter;

FIG. 4 is a schematic diagram of a non-limiting embodiment or aspect of an embedding space over which a uniformity function is applied according to the principles of the presently disclosed subject matter;

FIG. 5 is a diagram of a non-limiting embodiment or aspect of a query system according to the principles of the presently disclosed subject matter;

FIG. 6 is a flowchart of a non-limiting embodiment or aspect of a process for enhancing a distribution of graph feature embeddings in an embedding space to improve discrimination of graph features by a graph neural network (GNN) according to the principles of the presently disclosed subject matter; and

FIG. 7 is a diagram of a non-limiting embodiment or aspect of components of one or more devices of FIGS. 1-2, and 5.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “account identifier” may include one or more types of identifiers associated with a user account (e.g., a PAN, a card number, a payment card number, a payment token, and/or the like). In some non-limiting embodiments or aspects, an issuer institution may provide an account identifier (e.g., a PAN, a payment token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a payment token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the term “acquirer” may refer to an entity licensed by the transaction service provider and approved by the transaction service provider to originate transactions (e.g., payment transactions) using a portable financial device associated with the transaction service provider. As used herein, the term “acquirer system” may also refer to one or more computer systems, computer devices, and/or the like operated by or on behalf of an acquirer. The transactions may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments or aspects, an acquirer may be a financial institution, such as a bank.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like.

A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

As used herein, the terms “issuer institution,” “portable financial device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The terms “issuer institution” and “issuer institution system” may also refer to one or more computer systems operated by or on behalf of an issuer institution, such as a server computer executing one or more software applications. For example, an issuer institution system may include one or more authorization servers for authorizing a transaction.

As used herein, the term “merchant” may refer to one or more entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein, the term “merchant system” may refer to one or more computer systems operated by or on behalf of a merchant, such as a server computer executing one or more software applications. As used herein, the term “product” may refer to one or more goods and/or services offered by a merchant.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the portable financial device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway and/or to a payment gateway itself. As used herein, the term “payment gateway mobile application” may refer to one or more electronic devices and/or one or more software applications configured to provide payment services for transactions (e.g., payment transactions, electronic payment transactions, and/or the like).

As used herein, the term “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “point-of-sale (POS) system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed or configured to process online payment transactions through webpages, mobile applications, and/or the like.

The term “processor,” as used herein, may represent any type of processing unit, such as a single processor having one or more cores, one or more cores of one or more processors, multiple processors each having one or more cores, and/or other arrangements and combinations of processing units.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “transaction service provider” may refer to an entity that receives transaction authorization requests from merchants or other entities and provides guarantees of payment, in some cases through an agreement between the transaction service provider and the issuer institution. In some non-limiting embodiments or aspects, a transaction service provider may include a credit card company, a debit card company, and/or the like. As used herein, the term “transaction service provider system” may also refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to methods, systems, and computer program products for enhancing a distribution of graph feature embeddings in an embedding space to improve discrimination of graph features by a graph neural network (GNN). In some non-limiting embodiments or aspects, a graph learning system may include at least one processor programmed or configured to receive a dataset comprising graph data. For the dataset, the system may determine a measure of uniformity for the dataset, wherein the measure of uniformity is associated with a measure of distribution of the plurality of node embeddings in the embedding space. The system may also determine a measure of alignment for the plurality of groups of node embeddings, wherein the measure of alignment is associated with a measure of distribution of at least a portion of node embeddings of each group of the plurality of groups of node embeddings. From the measured uniformity and alignment, the system may generate a set of graph features used to train the GNN, resulting in an improved, trained GNN.

Therefore, the graph learning system of the present disclosure enables the generation of improved graph neural network (GNN) models. The graph learning system may provide a GNN that is trained such that node representations avoid converging to have the same values. In this way, the graph learning system may provide a GNN that is able to accurately detect relationships among entities and that is generated using reduced computational resources. For example, in non-limiting embodiments, generating distributions of graph embeddings and using such distributions for training a GNN results in an improved performance (e.g., faster and more efficient) trained GNN that can be used for collaborative filtering or other techniques to produce faster results while using less computational resources (e.g., processing cycles).

For the purpose of illustration, in the following description, while the presently disclosed subject matter is described with respect to methods, systems, and computer program products for multitask learning on time series data, e.g., for payment transactions, one skilled in the art will recognize that the disclosed subject matter is not limited to the non-limiting embodiments or aspects disclosed herein. For example, the methods, systems, and computer program products described herein may be used with a wide variety of settings, such as multitask learning on time series data using neural networks in any suitable setting, e.g., recommendations, predictions, regressions, classifications, fraud prevention, authorization, authentication, identification, feature selection, and/or the like.

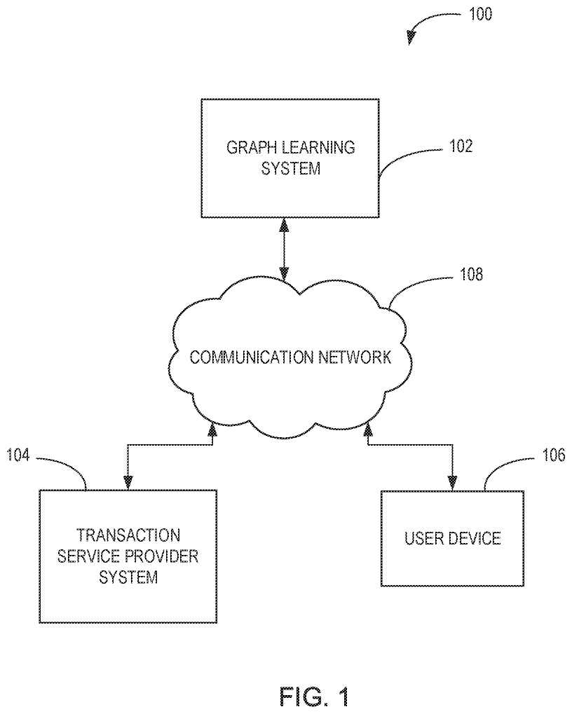

Referring now to FIG. 1, FIG. 1 is a diagram of a non-limiting embodiment or aspect of an environment 100 in which systems, computer program products, and/or methods, as described herein, may be implemented. As shown in FIG. 1, environment 100 includes graph learning system 102, transaction service provider system 104, user device 106, and communication network 108. Graph learning system 102, transaction service provider system 104, and/or user device 106 may interconnect (e.g., establish a connection to communicate) via wired connections, wireless connections, or a combination of wired and wireless connections.

Graph learning system 102 may include one or more devices configured to communicate with transaction service provider system 104 and/or user device 106 via communication network 108. For example, graph learning system 102 may include a server, a group of servers, and/or other like devices. In some non-limiting embodiments or aspects, graph learning system 102 may be associated with a transaction service provider system. For example, graph learning system 102 may be operated by the transaction service provider system 104. In another example, graph learning system 102 may be a component of transaction service provider system 104. In some non-limiting embodiments or aspects, graph learning system 102 may be in communication with a data storage device, which may be local or remote to graph learning system 102. In some non-limiting embodiments or aspects, graph learning system 102 may be capable of receiving information from, storing information in, transmitting information to, and/or searching information stored in the data storage device.

Transaction service provider system 104 may include one or more devices configured to communicate with graph learning system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider.

User device 106 may include a computing device configured to communicate with graph learning system 102, and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of environment 100 may perform one or more functions described as being performed by another set of systems or another set of devices of environment 100.

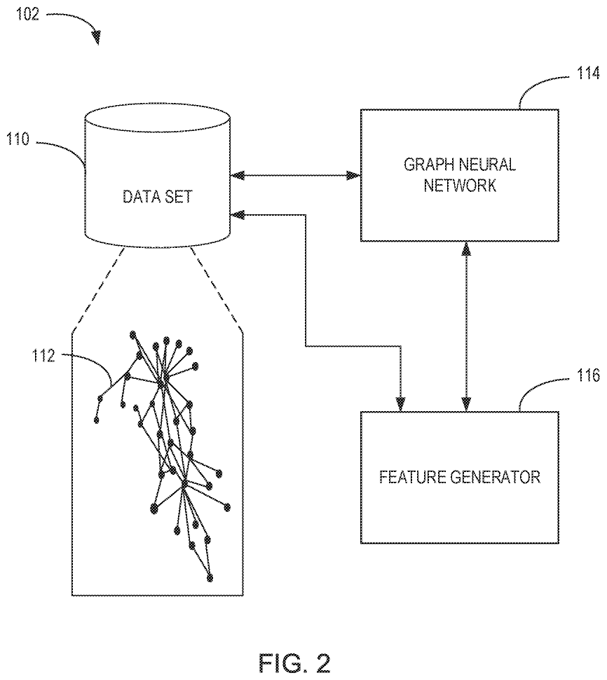

Referring to FIG. 2, a non-limiting embodiment or aspect of a graph learning system 102 is shown according to principles of the presently disclosed subject matter. The graph learning system 102 may comprise a dataset database 110, a graph neural network 114, and a feature generator 116. The number and arrangement of systems and devices shown in FIG. 2 are provided as an example. There may be additional systems and/or devices, fewer systems and/or devices, different systems and/or devices, and/or differently arranged systems and/or devices than those shown in FIG. 2. Furthermore, two or more systems or devices shown in FIG. 2 may be implemented within a single system or device, or a single system or device shown in FIG. 2 may be implemented as multiple, distributed systems or devices. Additionally or alternatively, a set of systems (e.g., one or more systems) or a set of devices (e.g., one or more devices) of graph learning system 102 may perform one or more functions described as being performed by another set of systems or another set of devices of graph learning system 102.

The dataset database 110 may include one or more devices capable of receiving information from and/or communicating information to GNN 114 and/or feature generator 116 (e.g., directly via wired or wireless communication connection, indirectly via a communication network, and/or the like). For example, dataset database 110 may include a computing device, such as a server, a group of servers, and/or other like devices. In some non-limiting embodiments or aspects, dataset database 110 may include a data storage device.

The dataset database 110 may store at least one dataset. The dataset stored in dataset database 110 may be represented by a graph 112 having a plurality of nodes and a plurality of edges.

In some non-limiting embodiments or aspects, the dataset database 110 may store a dataset comprising transaction data associated with historic electronic payment transactions processed over an electronic payment network.

In some non-limiting embodiments or aspects, the dataset database 110 may store a plurality of sets of data including a first data set comprising user data associated with users and a second data set comprising item (referred to interchangeably as entity) data associated with items with which users may interact. The user data and item data may be used to form a bipartite graph, which may be used to generate recommendations for users about the type of items they may be interested in, for example based on past user-item interactions of that user and other similar users, as determined by the GNN 114.

While several specific types of datasets are described herein, it will be appreciated that these are exemplary only, and other types of datasets may be used according to the present disclosure depending on the desired application of the GNN 114.

The graph 112 may comprise a plurality of nodes and a plurality of edges that represent the dataset(s). The graph 112 shown in FIG. 2 includes a plurality of nodes connected by a plurality of edges.

The dataset database 110 may also store graph data associated with the dataset. The graph data may comprise node data comprising data associated with parameters of each node in the graph 112. The graph data may comprise edge data comprising data associated with the edges in the graph 112.

As a non-limiting example, each node may represent an electronic payment transaction processed over the electronic payment network, the node data may correspond to parameters associated with the payment transaction. Parameters associated with the payment transaction may include, but are not limited to, transaction amount, transaction date, transaction time payment device data (e.g., primary account number (PAN), expiration date, cvv code), merchant, merchant category code, transaction type (e.g., card present, card not present), goods/services purchased, data elements specified in ISO 8583, and any other data associated with an electronic payment transaction, and combinations thereof.

As another non-limiting example, each node may represent a user and/or an item, and each edge may represent a relationship between one or more users (e.g., one or more nodes) and one or more items (e.g., one or more related nodes). In some non-limiting embodiments or aspects, the node data comprises user data associated with a plurality of users and item data associated with a plurality of items, and a first set of node embeddings may be based on the user data and a second set of node embeddings may be based on the item data.

The graph data stored in the dataset database 110 may comprise a plurality of node embeddings associated with a number of nodes in the graph 112. The graph data may comprise a plurality of edge embeddings associated with a number of edges in the graph 112. The node embeddings and/or the edge embeddings may be generated by a machine-learning model. For example, the GNN 114 may receive the dataset from dataset database 110 and, in response, may generate node embeddings and/or edge embeddings based on the data from the dataset. In other non-limiting embodiments or aspects, a machine-learning model separate from the GNN 114 (not shown) may generate the node embeddings and/or the edge embeddings based on the data from the dataset.

GNN 114 may include one or more devices configured to receive data, such as the graph 112 and/or other data from dataset database 110 and/or an output of the feature generator 116 and analyze the data to determine relationships therebetween. GNN 114 may comprise a data storage device to store data received by the GNN 114 and/or to store data generated by the GNN 114. In some non-limiting embodiments or aspects, an output of the GNN 114 may be input to the feature generator 116.

The feature generator 116 may receive a dataset comprising the graph data (e.g., at least one of a plurality of node data of a plurality of nodes, a plurality of edge data of a plurality of edges, a plurality of node embeddings associated with the nodes and/or a plurality of edge embeddings associated with the edges), and the graph data may be received or obtained, for example, from the dataset database 110 and/or the GNN 114.

Feature generator 116 may include one or more software applications and/or computing devices configured to receive data, such as the graph 112 and/or other data from dataset database 110 and/or an output of the GNN 114, and execute functions to determine and/or output parameters, such as uniformity and/or alignment (as described hereinafter), associated with the dataset. Feature generator 116 may generate a set of graph features (e.g., one or more feature vectors) based on the measure of uniformity, the measure of alignment, and the distance between the first set of node embeddings and the second set of node embeddings (as described hereinafter). Feature generator 116 may comprise a data storage device to store data received by the feature generator 116 and/or to store data generated by the feature generator 116. Output of the feature generator 116 may be input to the GNN 114 to train and improve the GNN 114.

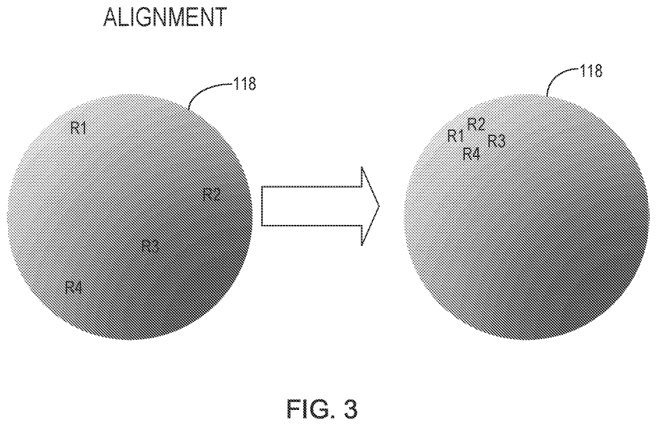

Referring to FIG. 3, a schematic diagram is shown of a non-limiting embodiment or aspect of an embedding space in which an alignment function is applied as described herein. FIG. 3 shows nodes R1-R4 arranged over an embedding space 118 before (left) and after (right) applying an alignment function. R1-R4 represent nodes that have similar properties and/or one or more of the same properties (e.g., parameters). As can be seen in FIG. 3, application of the alignment function may result in the nodes R1-R4 being as close to each other as possible over the embedding space 118 while still preserving properties about the individual nodes R1-R4 themselves.

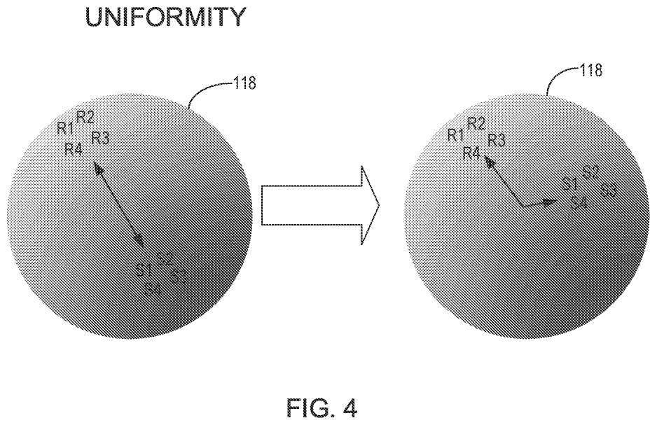

Referring to FIG. 4, a schematic diagram is shown of a non-limiting embodiment or aspect of an embedding space in which a uniformity function is applied as described herein. FIG. 4 shows a first group of nodes R1-R4 that have similar properties and/or one or more of the same properties (e.g., parameters) and a second group of nodes S1-S4 that have similar and/or one or more of the same properties, with the first group of nodes R1-R4 being dissimilar to the second group of nodes S1-S4. The first and second groups of nodes R1-R4, S1-S4 are arranged over an embedding space 118 before (left) and after (right) applying a uniformity function. As can be seen in FIG. 4, application of the uniformity function may result in nodes R1-R4 (and/or groups thereof) being further from dissimilar nodes S1-S4 (and/or groups thereof) over the embedding space 118 (e.g., as far as possible or as far as is determined based on the uniformity function).

Referring again to FIG. 2, in some non-limiting embodiments or aspects, in response to receiving the graph data, the feature generator 116 may determine (e.g., calculate) a distance between a first set of node embeddings of the plurality of node embeddings and a second set of node embeddings of the plurality of node embeddings in an embedding space.

The distance between node embeddings may be determined using any suitable technique. For example, the distance between the first and second set of node embeddings may be determined by calculating a Euclidean distance between each first node embedding of the first set of node embeddings and each second node embedding of the second set of node embeddings to provide a plurality of Euclidean distances.

With continued reference to FIG. 2, in some non-limiting embodiments or aspects, the feature generator 116 may automatically determine a measure of uniformity for the dataset received. The measure of uniformity may comprise a measure of distribution of the plurality of node embeddings in the embedding space. The measure of uniformity may be determined by the feature generator 116 based on the number of nodes in the graph 112 and the data associated with the parameters of each node in the graph 112. The measure of uniformity may be associated with a number of bits to encode the first set of node embeddings and the second set of node embeddings.

As a non-limiting example of the determination of uniformity for a dataset comprising user data, given a user representation Zᵤ=[z₁, z₂, . . . , zₙ]ϵ [symbol] ^{dx|N|} of all user instances in a batch, the coding rate may be defined as the number of binary bits to encode Z, which may be estimated by the following Equation (1):

$$R ( Z , ϵ ) \dot{=} \frac{1}{2} log det ( I + \frac{d}{N {ϵ}^{2}} {ZZ}^{⊤} ) \qquad ( 1 )$$

where I is the identity matrix (e.g., an n×n square matrix with ones on the main diagonal and zeros elsewhere), T denotes the matrix transpose, N and d denote the length and dimension of learned representation Z, and ϵ is the tolerated reconstruction error (e.g., set to a heuristic value of 0.05). R(Z, ϵ) may be a representation of compactness for the entire dataset.

As used herein, a coding rate is a measure of compactness of representations over all data instances. A lower coding rate corresponds to a more compact representation, while a higher coding rate corresponds to a less compact representation. Rate of reduction measures the difference of coding rate between the entire dataset and the sum of that of all groups. A higher reduction rate represents a more discriminative representation among different groups and more compact representation within the same group.

With continued reference to FIG. 2, in some non-limiting embodiments or aspects, the feature generator 116 may determine a plurality of groups of node embeddings, and each group comprises at least a portion of the plurality of node embeddings received by the feature generator 116.

The plurality of groups of node embeddings may be determined using any suitable technique.

For example, the feature generator 116 may determine the plurality of groups of node embeddings based on a probability matrix comprising a plurality of rows and a plurality of columns. Each group of the plurality of groups of node embeddings may comprise at least a portion of the plurality of node embeddings. Each row of the probability matrix may comprise a plurality of measures of probability, where each row of the probability matrix corresponds to a node of the plurality of nodes and each column of the probability matrix corresponds to a group of the plurality of groups of node embeddings. Each measure of probability of the plurality of measures of probability may represent a probability that the node will be assigned to the group based on the row and the column of the probability matrix.

For example, the feature generator 116 may determine the plurality of groups of node embeddings based on nearest neighbors of the plurality of nodes in the graph 112 using an adjacency matrix and a degree of each node of the plurality of nodes. It will be appreciated that one or more node clustering algorithms may be used to determine the plurality of groups of node embeddings.

With continued reference to FIG. 2, in some non-limiting embodiments or aspects, the feature generator 116 may automatically determine a measure of alignment for the plurality of groups of node embeddings. The measure of alignment may be associated with a measure of distribution of a portion of node embeddings of each group of the plurality of groups of node embeddings. As a non-limiting example of the determination of alignment for the plurality of groups of node embeddings, the feature generator 116 may determine the measure of alignment based on the probability matrix, the number of nodes in the graph and the data associated with the parameters of each node in the graph. The measure of alignment may be associated with a number of bits to encode each group of the plurality of groups of node embeddings.

As a non-limiting example of the determination of alignment for the plurality of groups of node embeddings, for a dataset comprising user data, given a user representation Zᵤ=[z₁, z₂, . . . , zₙ]ϵ [symbol] ^{dxN} it is assumed that the representations can be portioned to K groups with a probability matrix πϵ [symbol] ^{NxK}. Definitionally, πᵢₖϵ[0, 1] may indicate the probability of instance xᵢ assigned to the subset k, and

$${\sum }_{k = 1}^{K} {π}_{i k} = 1$$

for any iϵ[N]. The membership matrix for subset k may be defined as Πk=diag[π₁ₖ, π₂ₖ, . . . , π_{Nk}]ϵ [symbol] ^{NxN}, and the membership matrices for all groups are denoted as Π={Πₖ|k=[K]}. Thus, the coding rate for the entire data set may be equal to the summation of the coding rate for each subset as shown in Equation (2):

$${R}^{c} ( Z , ϵ \vert Π ) \dot{=} {\sum }_{k = 1}^{K} \frac{tr ( {Π}_{h} )}{2 \cdot N} \cdot log det ( I + \frac{d}{tr ( {Π}_{k} ) {ϵ}^{2}} Z {Π}_{k} {Z}^{⊤} ) . \qquad ( 2 )$$

R^{c}(Z, ϵ|Π) may be a representation of compactness for groups. Component tr( ) may be the Trace operator.

The rate reduction for representation learning may be determined according to the following equation (3):

$$Δ R ( Z , Π , ϵ ) = R ( Z , ϵ ) - {R}^{c} ( Z , ϵ \vert Π ) . \qquad ( 3 )$$

Thus, the rate reduction may be a composite of the measures of uniformity and alignment. The learned representation may be diverse in order to distinguish instances from different groups. For example, i) the coding rate for the entire dataset may be as large as possible to encourage diverse representations; and ii) the representations for different groups should span different subspaces and be compacted within a small volume for each subspace. Therefore, a good representation achieves a larger rate reduction rate (e.g., a difference between the coding rate for datasets and the summation of that for all groups). The rate reduction may be monotonic with respect to the norm of representation Z, so the scale of learned features may be normalized (e.g., each zᵢ in Z may be normalized).

The membership matrices (Π) may be designed using any suitable technique.

In some non-limiting embodiments or aspects, the membership matrices may be assembled based on an adjacency matrix, in order to enforce that connected nodes have similar representations by casting the node i and its neighbors as a group and mapping them to identical subspace. The adjacency matrix may be A=[a1, a2, . . . , a_{N}]∈ [symbol] ^{NxN} where aᵢϵ [symbol] ^{N} is the neighbor indicator vector of node i. A membership matrix may be assigned for the node group as Aᵢ=diag(aᵢ)ϵ [symbol] ^{NxN}. The coding rate for the group of node representations with membership matrix Aᵢ may be as shown in Equation (4):

$${R}_{𝒢}^{c} ( Z , ϵ \vert {A}_{i} ) \dot{=} \frac{tr ( {A}_{i} )}{2 N} \cdot log det ( I + \frac{d}{tr ( {A}_{i} ) {ϵ}^{2}} Z {A}_{i} {Z}^{⊤} ) . \qquad ( 4 )$$

Thus, for all nodes in the graph, the membership matrix set will be [symbol] ={Aᵢϵ [symbol] ^{NxN}, i∈[N]}. Since

$${\sum }_{i = 1}^{N} {A}_{i} = D ,$$

where D=diag(d₁, d₂, . . . , dₙ)ϵ [symbol] ^{NxN} is the degree matrix and di is the degree of node i. The different groups of nodes may be overlapping and may be computed multiple times, thus the coding rate of node representations for groups with the average degree d̅ of all nodes may be normalized. Consequently, the sum of the coding rate of node representations for each group may be determined according to Equation (5):

$${R}_{𝒢}^{c} ( Z , ϵ \vert {A}_{i} ) \dot{=} \frac{1}{d} {\sum }_{i = 1}^{N} \frac{tr ( {A}_{i} )}{2 N} \cdot log det ( I + \frac{d}{tr ( {A}_{i} ) {ϵ}^{2}} Z {A}_{i} {Z}^{⊤} ) . \qquad ( 5 )$$

where N is the total number of nodes in the graph, d̅ is the average degree of nodes, and [symbol] is the membership matrix set.

In some non-limiting embodiments or aspects, the membership matrices may be determined by deep clustering with graph topology. To predict cluster labels, a fully-connected network may be employed as the classifier. The multilayer perceptron (MLP) may take node embeddings E as input and predict correct labels on top of these embeddings. For a classification problem with deterministic labels, the following optimization in Equation (6) may be solved:

$$min - \frac{1}{n} {\sum }_{i = 1}^{n} log P ( y = {y}_{i} \vert {v}_{i} ) \qquad ( 6 )$$

where (p(y|vᵢ)=softmax (MLP(eᵢ)) is the prediction for node vᵢ. Considering that cluster assignments may be relaxed to be probability distributions, Equation (6) may be implemented as the cross-entropy loss between two distributions q(y|vᵢ) and p(y|vᵢ) (see Equation (7)):

$$ℒ = - \frac{1}{n} {\sum }_{n = 1}^{n} {\sum }_{y = 1}^{k} q ( y \vert {v}_{i} ) log p ( y \vert {v}_{i} ) \qquad ( 7 )$$

where q(y|vᵢ)=c_{iy} is the cluster assignments. When q(y|vᵢ) is deterministic, minimizing Equation (7) is equivalent to solving Equation (6).

With this formulation, given the current cluster assignments, the model parameters may be updated by minimizing cross-entropy between q and p. When updating cluster assignments, assignments may be optimized that minimize Formula (7) based on the currently predicted distribution p. This can be formulated as an optimal transportation problem where Pϵ [symbol] ^{nxk} with entries p_{iy}=−log(p(y|vᵢ)) as the cost matrix. Matrix C may be an element of the transportation polytope given by Formula (8):

$$U ( r , c ) := \{ C ∈ {ℝ}_{+}^{n \times k} \vert C 1 = r , {C}^{⊤} 1 = c \} \qquad ( 8 )$$

where r=1ϵ [symbol] ⁿ and

$$C = \frac{n}{k} 1$$

ϵ [symbol] ^{k}, which corresponds to a restriction of equipartition, and the solution should minimize the cost according to Formula (9)

$$min 〈 C , P 〉 . \qquad ( 9 )$$

This problem can be solved in near-linear time using the Sinkhorn-Knopp matrix scaling algorithm, and the optimal solution C can be used as Π in Equation (2).

With continued reference to FIG. 2, in some non-limiting embodiments or aspects, the feature generator 116 may generate a set of graph features based on the measure of uniformity, the measure of alignment, and the distance between the first set of node embeddings and the second set of node embeddings. The set of graph features may be determined according to the following Equation (10):

$${ℒ}_{DirectMCR} = {l}_{align} + γ Δ R ( Z , Π , ϵ ) . \qquad ( 10 )$$

In Equation (10), γ may be a weight that controls the desired degree of uniformity, which may depend on characteristics of the dataset.

In Equation (10), l_{align} may be calculated based on the in-batch pairwise distance between the first and second set of node embeddings. Using in-batch instances may provide for an I_{align} more consistent with the actual data distribution (e.g., the distributions of users (pᵤₛₑᵣₛ) and items (pᵢₜₑₘₛ)), which may reduce the bias as recommender systems.

In some non-limiting embodiments or aspects, l_{align} may be determined according to the following Equation (11):

$${l}_{align} = {𝔼}_{( u , i ) \sim {p}_{pos}} {‖ \tilde{f ( u )} - \tilde{f ( i )} ‖}^{2} \qquad ( 11 )$$

The above-described set of graph features may be generated using input only including a batch of positive user-item pairs and may not need additional negative samples to discriminate between positive and negative interactions.

With continued reference to FIG. 2, the determined set of graph features generated by the feature generator 116 as described herein may be input to the GNN 114 to train and/or further train the GNN 114. Input of the set of graph features to train the GNN 114 may improve the GNN 114 by yielding a GNN 114 that generates a more accurate output (e.g., prediction, recommendation, and the like) and one that generates accurate output more efficiently and using fewer processing resources. The GNN 114 trained on the output from the feature generator 116 may also avoid the phenomenon of dimensional collapse exhibited by many existing systems. Instead, the GNN 114 trained as described herein may comprise representations of positive-related user-item pairs close to each other while each representation also preserves as much information about the user/item itself as possible.

The GNN 114 trained using the set of graph features may be validated using a validation data set separate from the training data set used to train the GNN 114. The validation data set may be input to the GNN 114, and the performance of the trained GNN 114 may be evaluated using any suitable technique. For example, a Recall@K metric may be applied to evaluate the performance of the trained GNN 114 on the validation data set.

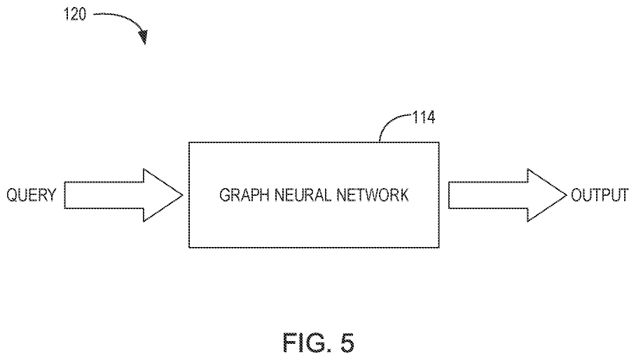

Referring to FIG. 5, a query system 120 is shown according to non-limiting embodiments or aspects of the presently disclosed subject matter. The query system 120 may comprise the GNN 114 trained as described herein. The GNN 114 may receive a query, process the query, and automatically generate and transmit an output to the query. The query system 120 may function as a recommendation system using the GNN 114, with the output comprising a prediction and/or recommendation in response to the query input.

In some non-limiting embodiments or aspects, the query system 120 may receive inquiries regarding whether an electronic payment transaction is fraudulent, and the GNN 114 (trained on historical electronic payment transaction data) may generate an output predicting whether the electronic payment transaction is fraudulent. For example, transaction service provider system 104 (see FIG. 1) (and/or an issuer system of an issuer and/or a merchant system of a merchant and/or an acquirer system of an acquirer involved in processing the transaction) may query the GNN 114. Parameters of the electronic payment transaction that is the subject of the query may be input to the GNN 114, and the GNN 114 may automatically generate the output predicting whether the electronic payment transaction is fraudulent based on the parameters of the electronic payment transaction. The output from the GNN 114 may be used by a payment network (e.g., including at least one of transaction service provider system 104, issuer system, merchant system, and acquirer system) to process the transaction (or terminate processing thereof). For example, the transaction may automatically be authorized in response to the GNN 114 outputting that the transaction is not fraudulent, or the transaction may automatically be declined in response to the GNN 114 outputting that the transaction is fraudulent.

In some non-limiting embodiments or aspects, the query system 120 may comprise a recommendation system for recommending at least one item for a user. For example, the recommendation system may generate a recommendation for an item the user might be interested in purchasing, watching, traveling to, experiencing, or with which the user may otherwise be interested in engaging. The query to the GNN 114 may include an identification of the user and/or parameters associated with the user. The GNN 114 may be trained on data of other users and data of items and/or the interactions therebetween. Based on the input identifying the user, the GNN 114 may automatically generate the output. The output may comprise at least one recommended item for the subject user. The GNN 144 may transmit the output to the user device 106 (see FIG. 1) of the user to cause the user device 106 to display the at least one recommended item for the user.

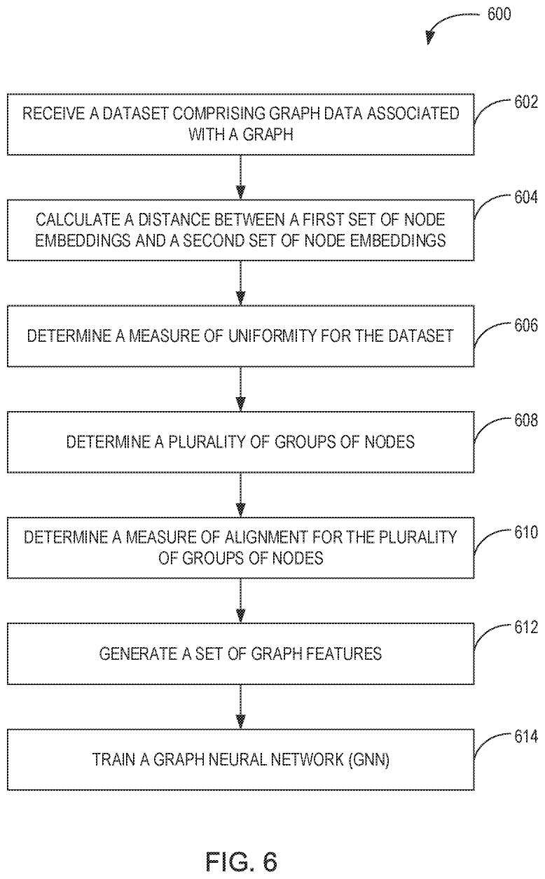

Referring now to FIG. 6, FIG. 6 is a flowchart of a non-limiting embodiment or aspect of a process 600 for enhancing a distribution of graph feature embeddings in an embedding space to improve discrimination of graph features by a graph neural network (GNN). In some non-limiting embodiments or aspects, one or more of the steps of process 600 may be performed (e.g., completely, partially, etc.) by graph learning system 102 (e.g., one or more devices of graph learning system 102). In some non-limiting embodiments or aspects, one or more of the steps of process 600 may be performed (e.g., completely, partially, etc.) by another device or a group of devices separate from or including graph learning system 102, such as transaction service provider system 104, and/or user device 106. It will be appreciated that additional, fewer, different, and/or a different order of steps may be used in non-limiting embodiments or aspects. It will be appreciated that a subsequent step may be executed automatically and/or in response to a preceding step.

As shown in FIG. 6, at step 602, process 600 may include receiving a dataset comprising graph data associated with a graph. For example, graph learning system 102 may receive a dataset from dataset database 110 comprising graph data associated with the graph 112. In some non-limiting embodiments, the graph 112 may include a plurality of nodes and a plurality of edges, and the graph data may include a plurality of node embeddings associated with a number of nodes in the graph 112 and node data associated with each node of the graph 112. The node data may include data associated with parameters of each node in the graph 112. Additionally or alternatively, the node data may include user data associated with a plurality of users and/or entity data associated with a plurality of entities. The first set of node embeddings may be based on the user data and/or the second set of node embeddings may be based on the entity data.

As shown in FIG. 6, at step 604, process 600 may include calculating a distance between a first set of node embeddings and a second set of node embeddings. For example, graph learning system 102 (e.g., feature generator 116 thereof) may calculate a distance between a first set of node embeddings and a second set of node embeddings. In some non-limiting embodiments or aspects, feature generator 116 may calculate a distance between the first set of node embeddings of a plurality of node embeddings and the second set of node embeddings of the plurality of node embeddings in an embedding space, where the plurality of node embeddings are based on node data associated with each node of a graph. In some non-limiting embodiments or aspects, feature generator 116 may calculate a Euclidean distance between each first node embedding of the first set of node embeddings and each second node embedding of the second set of node embeddings to provide a plurality of Euclidean distances.

As shown in FIG. 6, at step 606, process 600 may include determining a measure of uniformity for the dataset. For example, graph learning system 102 (e.g., feature generator 116 thereof) may determine a measure of uniformity for a dataset that includes graph data associated with the graph 112. In some non-limiting embodiments or aspects, the measure of uniformity may be associated with a measure of distribution of a plurality of node embeddings in an embedding space, where the plurality of node embeddings are associated with a number of nodes in the graph 112.

In some non-limiting embodiments or aspects, feature generator 116 may determine the measure of uniformity for the dataset based on the number of nodes in the graph 112 and data associated with parameters of each node in the graph 112. The measure of uniformity may be associated with a number of bits to encode the first set of node embeddings and the second set of node embeddings.

As shown in FIG. 6, at step 608, process 600 may include determining a plurality of groups of nodes. For example, graph learning system 102 (e.g., feature generator 116 thereof) may determine a plurality of groups of nodes. Each group of the plurality of groups of node embeddings may include at least a portion of a plurality of node embeddings associated with a number of nodes in the graph 112.

In some non-limiting embodiments or aspects, feature generator 116 may determine the plurality of groups of node embeddings based on a probability matrix comprising a plurality of rows and a plurality of columns, each group of the plurality of groups of node embeddings may include at least a portion of the plurality of node embeddings, and each row of the probability matrix comprising a plurality of measures of probability. Each row of the probability matrix may correspond to a node of the plurality of nodes and each column of the probability matrix may correspond to a group of the plurality of groups of node embeddings, and each measure of probability of the plurality of measures of probability may represent a probability that the node will be assigned to the group based on the row and the column of the probability matrix. In some non-limiting embodiments or aspects, graph learning system 102 may determine each group of the plurality of groups of node embeddings based on nearest neighbors of the plurality of nodes in the graph using an adjacency matrix and a degree of each node of the plurality of nodes.

As shown in FIG. 6, at step 610, process 600 may include determining a measure of alignment for the plurality of groups of nodes. For example, graph learning system 102 (e.g., feature generator 116 thereof) may determine a plurality of groups of nodes. In some non-limiting embodiments or aspects, feature generator 116 may determine the measure of alignment based on a probability matrix, a number of nodes in the graph 112, and data associated with parameters of each node in the graph 112. The measure of alignment may be associated with a number of bits to encode each group of the plurality of groups of node embeddings.

As shown in FIG. 6, at step 612, process 600 may include generating a set of graph features. For example, graph learning system 102 (e.g., feature generator 116 thereof) may generate a set of graph features. In some non-limiting embodiments or aspects, feature generator 116 may generate a set of graph features based on a measure of uniformity, a measure of alignment, and/or a distance between a first set of node embeddings and a second set of node embeddings.

As shown in FIG. 6, at step 614, process 600 may include training a graph neural network (GNN). For example, graph learning system 102 may train a GNN. In some non-limiting embodiments or aspects, graph learning system 102 (e.g., feature generator 116 thereof) may train the GNN 114 based on a set of graph features to provide a trained GNN 114. In some non-limiting embodiments or aspects, graph learning system 102 may validate the trained GNN 114 based on at least a portion of the set of graph features.

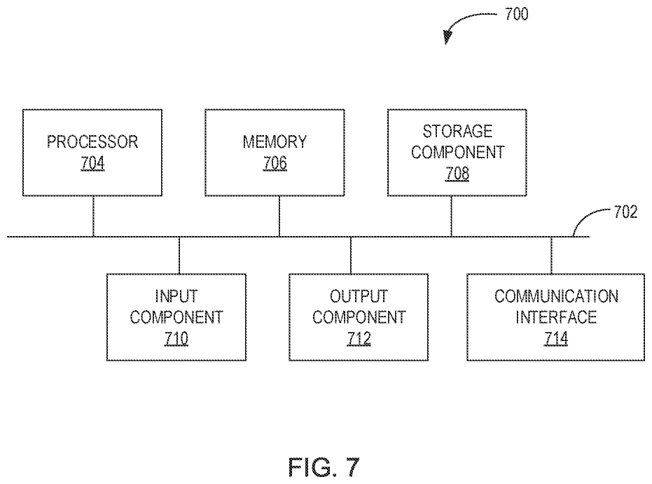

Referring now to FIG. 7, FIG. 7 is a diagram of example components of a device 700. Device 700 may correspond to one or more devices of graph learning system 102, transaction service provider system 104, user device 106, dataset database 110, graph neural network 114, and/or feature generator 116 from FIGS. 1-2 and 5, for example. In some non-limiting embodiments or aspects, graph learning system 102, transaction service provider system 104, user device 106, dataset database 110, graph neural network 114, and/or feature generator 116 may include at least one device 700 and/or at least one component of device 700.

As shown in FIG. 7, device 700 may include bus 702, processor 704, memory 706, storage component 708, input component 710, output component 712, and communication interface 714. Bus 702 may include a component that permits communication among the components of device 700. In some non-limiting embodiments or aspects, processor 704 may be implemented in hardware, firmware, or a combination of hardware and software. For example, processor 704 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 706 may include random access memory (RAM), read-only memory (ROM), and/or another type of dynamic or static storage device (e.g., flash memory, magnetic memory, optical memory, and/or the like) that stores information and/or instructions for use by processor 704.

Storage component 708 may store information and/or software related to the operation and use of device 700. For example, storage component 708 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 710 may include a component that permits device 700 to receive information, such as via user input (e.g., a touch screen display, a keyboard, a keypad, a mouse, a button, a switch, a microphone, a camera, and/or the like). Additionally or alternatively, input component 710 may include a sensor for sensing information (e.g., a global positioning system (GPS) component, an accelerometer, a gyroscope, an actuator, and/or the like). Output component 712 may include a component that provides output information from device 700 (e.g., a display, a speaker, one or more light-emitting diodes (LEDs), and/or the like).

Communication interface 714 may include a transceiver-like component (e.g., a transceiver, a receiver and transmitter that are separate, and/or the like) that enables device 700 to communicate with other devices, such as via a wired connection, a wireless connection, or a combination of wired and wireless connections. Communication interface 714 may permit device 700 to receive information from another device and/or provide information to another device. For example, communication interface 714 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 700 may perform one or more processes described herein. Device 700 may perform these processes based on processor 704 executing software instructions stored by a computer-readable medium, such as memory 706 and/or storage component 708. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 706 and/or storage component 708 from another computer-readable medium or from another device via communication interface 714. When executed, software instructions stored in memory 706 and/or storage component 708 may cause processor 704 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 7 are provided as an example. In some non-limiting embodiments or aspects, device 700 may include additional components, fewer components, different components, or differently arranged components than those shown in FIG. 7. Additionally or alternatively, a set of components (e.g., one or more components) of device 700 may perform one or more functions described as being performed by another set of components of device 700.

### EXAMPLES

Experiments were conducted on several public datasets to validate the effectiveness of the system described herein (DirectMCR) and compare it to other state-of-the-art collaborative filtering (CF) systems.

### Table 1

| | | | | Averages | |
|---|---|---|---|---|---|
| Dataset | Users | Items | Interactions | Items/User | Density |
| Beauty | 22.4k | 12.1k | 198.5k | 8.9 | 0.07% |
| Book | 52.6k | 91.5k | 298.4k | 10.7 | 0.06% |
| Gowalla | 29.9k | 41.0k | 1027.4k | 34.4 | 0.08% |
| Yelp2018 | 31.7k | 38.0k | 1561.4k | 49.3 | 0.13% |

Referring to Table 1, 3 public datasets were used as follows:

Beauty and Book: One of the series of product review datasets crawled from Amazon, with the data split into separate datasets by the top-level product category.

Gowalla: A check-in dataset obtained from Gowalla where users share their locations by checking-in.

Yelp2018: A business recommendation dataset, including restaurants, bars, and the like, using transactions records after Jan. 1, 2018.

These datasets were preprocessed by removing repeated interactions and ensuring that each user and item had at least 5 associated interactions. Table 1 reports the statistics of the dataset after preprocessing.

The performance of the DirectMCR model of the present disclosure was compared against the following state-of-the-art CF systems:

BPRMF: A negative-sampling method that optimizes matrix factorization (MF) with a pairwise ranking loss, where the negative item is randomly sampled from the item set (Rendel et al. (2009)).

LightGCN: A simplified graph convolution network for CF that performs linear propagation between neighbors on the user-item bipartite graph (He et al. (2020)).

SGL: A self-supervised graph learning for graph-based recommendation (Wu et al. (2021)).

DirectAU: A learning framework that achieves uniformity and alignment but fails to address dimension collapse (Wang et al. (2022)).

To test each dataset, each user's interactions were randomly split into training/validation/test sets with the ratio of 80%/10%/10%. To evaluate performance of the top-K recommendation, Recall@K evaluation metrics were employed, which measures how many target items are retrieved in the recommendation result. The ranking list of all items (except for the training items in the user history) were considered, as opposed to ranking a smaller set of random items together with the target items. Each experiment was repeated 5 times with different random seeds, and the report of the average score is shown in Table 2:

| Dataset | Beauty | Gowalla | Yelp |
|---|---|---|---|
| BPRMF | 0.1153 | 0.1263 | 0.0693 |
| LightGCN | 0.1201 | 0.1871 | 0.0833 |
| SGL | 0.1334 | 0.1943 | 0.0946 |
| DirectAU | 0.1400 | 0.2014 | 0.1096 |
| DirectMCR | 0.1438 | 0.2068 | 0.1103 |

From the experimental results, Direct MCR exhibited the best performance. Thus, directly optimizing coding rate reduction function yields performance improvements of the GNN. This demonstrates that the properties of dimension collapse strongly agree with representation quality in CF, which existing models fail to address and lead to their inferior results.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A system, comprising:
at least one processor programmed or configured to:
receive a dataset comprising graph data associated with a graph, the graph comprising a plurality of nodes and a plurality of edges, the graph data comprising a plurality of node embeddings associated with a number of nodes in the graph and node data associated with each node of the graph, the node data comprising data associated with parameters of each node in the graph;
calculate a distance between a first set of node embeddings of the plurality of node embeddings and a second set of node embeddings of the plurality of node embeddings in an embedding space, the plurality of node embeddings based on the node data associated with each node of the graph;
determine a measure of uniformity for the dataset, the measure of uniformity associated with a measure of distribution of the plurality of node embeddings in the embedding space;
determine a plurality of groups of node embeddings, each group of the plurality of groups of node embeddings comprising at least a portion of the plurality of node embeddings;
determine a measure of alignment for the plurality of groups of node embeddings, the measure of alignment associated with a measure of distribution of at least a portion of node embeddings of each group of the plurality of groups of node embeddings;
generate a set of graph features based on the measure of uniformity, the measure of alignment, and the distance between the first set of node embeddings and the second set of node embeddings; and
train a graph neural network (GNN) based on the set of graph features to provide a trained GNN.

2. The system of claim 1, wherein the at least one processor is further programmed or configured to:
validate the trained GNN based on at least a portion of the set of graph features.

3. The system of claim 1, wherein, when calculating the distance between the first set of node embeddings and the second set of node embeddings in the embedding space, the at least one processor is programmed or configured to:
calculate a Euclidean distance between each first node embedding of the first set of node embeddings and each second node embedding of the second set of node embeddings to provide a plurality of Euclidean distances.

4. The system of claim 1, wherein, when determining the measure of uniformity for the dataset, the at least one processor is programmed or configured to:
determine the measure of uniformity for the dataset based on the number of nodes in the graph and the data associated with the parameters of each node in the graph, wherein the measure of uniformity is associated with a number of bits to encode the first set of node embeddings and the second set of node embeddings.

5. The system of claim 1, wherein, when determining the plurality of groups of node embeddings, the at least one processor is programmed or configured to:
determine the plurality of groups of node embeddings based on a probability matrix comprising a plurality of rows and a plurality of columns, each group of the plurality of groups of node embeddings comprising at least a portion of the plurality of node embeddings, and each row of the probability matrix comprising a plurality of measures of probability, wherein each row of the probability matrix corresponds to a node of the plurality of nodes and each column of the probability matrix corresponds to a group of the plurality of groups of node embeddings, and wherein each measure of probability of the plurality of measures of probability represents a probability that the node will be assigned to the group based on the row and the column of the probability matrix; and
wherein, when determining the measure of alignment for the plurality of groups of node embeddings, the at least one processor is programmed or configured to:
determine the measure of alignment based on the probability matrix, the number of nodes in the graph and the data associated with the parameters of each node in the graph, wherein the measure of alignment is associated with a number of bits to encode each group of the plurality of groups of node embeddings.

6. The system of claim 1, wherein the node data comprises user data associated with a plurality of users and entity data associated with a plurality of entities, and wherein the first set of node embeddings is based on the user data and the second set of node embeddings is based on the entity data.

7. The system of claim 1, wherein, when determining the plurality of groups of node embeddings, the at least one processor is programmed or configured to:
determine each group of the plurality of groups of node embeddings based on nearest neighbors of the plurality of nodes in the graph using an adjacency matrix and a degree of each node of the plurality of nodes.

8. A computer-implemented method, comprising:
receiving, with at least one processor, a dataset comprising graph data associated with a graph, the graph comprising a plurality of nodes and a plurality of edges, the graph data comprising a plurality of node embeddings associated with a number of nodes in the graph and node data associated with each node of the graph, the node data comprising data associated with parameters of each node in the graph;
calculating, with at least one processor, a distance between a first set of node embeddings of the plurality of node embeddings and a second set of node embeddings of the plurality of node embeddings in an embedding space, the plurality of node embeddings based on the node data associated with each node of the graph;
determining, with at least one processor, a measure of uniformity for the dataset, the measure of uniformity associated with a measure of distribution of the plurality of node embeddings in the embedding space;
determining, with at least one processor, a plurality of groups of node embeddings, each group of the plurality of groups of node embeddings comprising at least a portion of the plurality of node embeddings;
determining, with at least one processor, a measure of alignment for the plurality of groups of node embeddings, the measure of alignment associated with a measure of distribution of at least a portion of node embeddings of each group of the plurality of groups of node embeddings;
generating, with at least one processor, a set of graph features based on the measure of uniformity, the measure of alignment, and the distance between the first set of node embeddings and the second set of node embeddings; and
training, with at least one processor, a graph neural network (GNN) based on the set of graph features to provide a trained GNN.

9. The computer-implemented method of claim 8, further comprising:
validating, with at least one processor, the trained GNN based on at least a portion of the set of graph features.

10. The computer-implemented method of claim 8, wherein calculating the distance between the first set of node embeddings and the second set of node embeddings in the embedding space comprises:
calculating a Euclidean distance between each first node embedding of the first set of node embeddings and each second node embedding of the second set of node embeddings to provide a plurality of Euclidean distances.

11. The computer-implemented method of claim 8, wherein determining the measure of uniformity for the dataset comprises:
determining the measure of uniformity for the dataset based on the number of nodes in the graph and the data associated with the parameters of each node in the graph, wherein the measure of uniformity is associated with a number of bits to encode the first set of node embeddings and the second set of node embeddings.

12. The computer-implemented method of claim 8, wherein determining the plurality of groups of node embeddings comprises:
determining the plurality of groups of node embeddings based on a probability matrix comprising a plurality of rows and a plurality of columns, each group of the plurality of groups of node embeddings comprising at least a portion of the plurality of node embeddings, and each row of the probability matrix comprising a plurality of measures of probability, wherein each row of the probability matrix corresponds to a node of the plurality of nodes and each column of the probability matrix corresponds to a group of the plurality of groups of node embeddings, and wherein each measure of probability of the plurality of measures of probability represents a probability that the node will be assigned to the group based on the row and the column of the probability matrix; and
wherein determining the measure of alignment for the plurality of groups of node embeddings comprises:
determining the measure of alignment based on the probability matrix, the number of nodes in the graph and the data associated with the parameters of each node in the graph, wherein the measure of alignment is associated with a number of bits to encode each group of the plurality of groups of node embeddings.

13. The computer-implemented method of claim 8, wherein the node data comprises user data associated with a plurality of users and entity data associated with a plurality of entities, and wherein the first set of node embeddings is based on the user data and the second set of node embeddings is based on the entity data.

14. The computer-implemented method of claim 8, wherein determining the plurality of groups of node embeddings comprises determining each group of the plurality of groups of node embeddings based on nearest neighbors of the plurality of nodes in the graph using an adjacency matrix and a degree of each node in the plurality of nodes.

15. A computer program product comprising at least one non-transitory computer-readable medium comprising one or more instructions that, when executed by at least one processor, cause the at least one processor to:
receive a dataset comprising graph data associated with a graph, the graph comprising a plurality of nodes and a plurality of edges, the graph data comprising a plurality of node embeddings associated with a number of nodes in the graph and node data associated with each node of the graph, the node data comprising data associated with parameters of each node in the graph;
calculate a distance between a first set of node embeddings of the plurality of node embeddings and a second set of node embeddings of the plurality of node embeddings in an embedding space, the plurality of node embeddings based on the node data associated with each node of the graph;
determine a measure of uniformity for the dataset, the measure of uniformity associated with a measure of distribution of the plurality of node embeddings in the embedding space;
determine a plurality of groups of node embeddings, each group of the plurality of groups of node embeddings comprising at least a portion of the plurality of node embeddings;
determine a measure of alignment for the plurality of groups of node embeddings, the measure of alignment associated with a measure of distribution of at least a portion of node embeddings of each group of the plurality of groups of node embeddings;
generate a set of graph features based on the measure of uniformity, the measure of alignment, and the distance between the first set of node embeddings and the second set of node embeddings; and
train a graph neural network (GNN) based on the set of graph features to provide a trained GNN.

16. The computer program product of claim 15, wherein the one or more instructions further cause the at least one processor to:
validate the trained GNN based on at least a portion of the set of graph features.

17. The computer program product of claim 15, wherein the one or more instructions that cause the at least one processor to calculate the distance between the first set of node embeddings and the second set of node embeddings in the embedding space cause the at least one processor to:
calculate a Euclidean distance between each first node embedding of the first set of node embeddings and each second node embedding of the second set of node embeddings to provide a plurality of Euclidean distances.

18. The computer program product of claim 15, wherein the one or more instructions that cause the at least one processor to determine the measure of uniformity for the dataset cause the at least one processor to:
determine the measure of uniformity for the dataset based on the number of nodes in the graph and the data associated with the parameters of each node in the graph, wherein the measure of uniformity is associated with a number of bits to encode the first set of node embeddings and the second set of node embeddings.

19. The computer program product of claim 15, wherein the one or more instructions that cause the at least one processor to determine the plurality of groups of node embeddings cause the at least one processor to:
determine the plurality of groups of node embeddings based on a probability matrix comprising a plurality of rows and a plurality of columns, each group of the plurality of groups of node embeddings comprising at least a portion of the plurality of node embeddings, and each row of the probability matrix comprising a plurality of measures of probability, wherein each row of the probability matrix corresponds to a node of the plurality of nodes and each column of the probability matrix corresponds to a group of the plurality of groups of node embeddings, and wherein each measure of probability of the plurality of measures of probability represents a probability that the node will be assigned to the group based on the row and the column of the probability matrix; and
wherein the one or more instructions that cause the at least one processor to determine the measure of alignment for the plurality of groups of node embeddings cause the at least one processor to:
determine the measure of alignment based on the probability matrix, the number of nodes in the graph and the data associated with the parameters of each node in the graph, wherein the measure of alignment is associated with a number of bits to encode each group of the plurality of groups of node embeddings.

20. The computer program product of claim 15, wherein the one or more instructions that cause the at least one processor to determine the plurality of groups of node embeddings cause the at least one processor to:
determine each group of the plurality of groups of node embeddings based on nearest neighbors of the plurality of nodes in the graph using an adjacency matrix and a degree of each node of the plurality of nodes.
